(19) United States
(12) Patent Application Publication
(10) Pub. No.: US 2025/0328118 A1
(43) Pub. Date: Oct. 23, 2025

(54) LOW POWER PASSIVE INFRARED HUMAN SENSOR WITH MACHINE LEARNING

(71) Applicant: Useful Sensors Inc., Mountain View, CA (US)

(72) Inventors: James Muyao Wang, Rosamond, CA (US); William Meng, Palo Alto, CA (US); Peter Charles Warden, San Francisco, CA (US)

(73) Assignee: Useful Sensors Inc., Mountain View, CA (US)

(21) Appl. No.: 19/185,781

(22) Filed: Apr. 22, 2025

Related U.S. Application Data
(60) Provisional application No. 63/637,418, filed on Apr. 23, 2024.
(60) Provisional application No. 63/709,569, filed on Oct. 21, 2024.

(51) Int. Cl. G05B 19/042; G01J 5/00

(52) U.S. Cl. CPC G05B 19/042; G01J 5/0025; G05B 2219/25255; G05B 2219/25257

(57) ABSTRACT

Techniques for machine learning-based motion detection are disclosed. One or more passive infrared (IR) sensors are accessed and are coupled to a microcontroller for analysis. The one or more passive infrared sensors are mounted to receive light through a lens. IR data is collected from the one or more passive infrared sensors. The IR data is sampled at a sampling rate by the microcontroller. Movement is detected based on the collected IR data from the one or more passive infrared sensors. IR data is sent to a machine learning model. The machine learning model is based on a TinyML model. The TinyML model operates on the microcontroller. The TinyML model classifies the one or more animate and inanimate sources of the movement. Sources of movement include humans and human activity including adults and children.

### RELATED APPLICATIONS

This application claims the benefit of U.S. provisional patent applications “Low Power Passive Infrared Human Sensor With Machine Learning” Ser. No. 63/637,418, filed Apr. 23, 2024, and “Transformer Model Training For Speech Recognition” Ser. No. 63/709,569, filed Oct. 21, 2024.

Each of the foregoing applications is hereby incorporated by reference in its entirety.

### FIELD OF ART

This application relates generally to sensing humans and more particularly to a low power passive infrared human sensor with machine learning.

### BACKGROUND

Alarms have sounded throughout the history of mankind. An alarm can be raised by a messenger heralding the advancing army of an enemy. An alarm can be communications that signal dangerous weather patterns. Alarms can alert building occupants of an impending life-threatening situation such as a fire. The response to an alarm typically involves many types of resources. For instance, defenses can be marshalled to protect a country. Shelter can be sought to escape perilous weather. Safety equipment and personnel can be assembled to respond to and fight a building fire, guide building occupants to safety, and so on. While alarms can be helpful, the problem of false alarms has troubled people throughout history. Some false alarms can be due to hardware failures. Other false alarms can be due to unscrupulous people that seek to be troublesome.

An example of a false alarm is a false fire alarm. Fire alarm systems can sometimes fail and report an emergency that isn't authentic. Unscrupulous people can trigger fire alarm systems to likewise report an emergency that isn't factual. In such a case, fear, panic, and possible personal injury are possible. Another example of a false alarm is a 9-1-1 call that reports an emergency event that does not exist. One or more agencies and associated equipment can be involved in the response to that 9-1-1 call. While responding, the resources of agencies, equipment, and personnel are unavailable for other emergencies, thus causing significant costs and risks to society. A more mundane example of a false alarm can include a school-aged child that reports an illness that isn't genuine and stays home from school. Staying home from school can put the child at a disadvantage because new subject matter can be introduced in the classroom and would be missed during the absence. Resulting make-up assignments will need to be completed, often at the expense of extra time, effort, and sometimes aggravation for the student. The child can learn that falsehoods can seem advantageous, but only in a very short-term sense.

False alarms involve costs toward individuals, organizations, or society in general. These costs can have a direct impact on finances of various people or organizations. For example, wages must be paid for personal responding to false alarms. Equipment can have fuel costs and other operating costs. Further, the unnecessary use of equipment can cause it to wear out before expected equipment lifetimes. Improvements in detection accuracy of various events can be expected to greatly enhance alarm discrimination and benefit society.

### SUMMARY

Electronic devices that sense motion are ubiquitous in the modern age. Motion sensing devices can be beneficial in widely diverse areas of life. A common motion detection application includes the motion-detecting capability in a lighting fixture. The motion detecting apparatus, upon sensing motion, can automatically activate the illumination device in the lighting fixture. Motion activated lighting can be useful for the enhancement of safe operation of vehicles, pedestrians, and so on. Motion-activated lighting can enhance building security and personal safety because lighting can be a deterrent to criminal activity. Motion activated sensing can include systems that provide operator safety around industrial machinery. Another common motion detection apparatus can be a standalone device that can activate or deactivate building environmental systems depending on building occupancy. This can be useful for energy efficiency, cost savings, and so on. Another motion detection application can be a wall thermostat with an informational display that can be activated or whose contents can be modified depending on nearby motion.

Techniques for machine learning-based motion detection are disclosed. One or more passive infrared (IR) sensors are accessed and are coupled to a microcontroller for analysis. The one or more passive infrared sensors are mounted to receive light through a lens. IR data is collected from the one or more passive infrared sensors. The IR data is sampled at a sampling rate by the microcontroller. Movement is detected based on the collected IR data from the one or more passive infrared sensors. IR data is sent to a machine learning model. The machine learning model is based on a TinyML model. The TinyML model operates on the microcontroller. The TinyML model classifies the one or more animate and inanimate sources of the movement. Sources of movement include humans and human activity including adults and children.

A processor-implemented method for sensing humans is disclosed comprising: accessing one or more passive infrared (PIR) sensors, wherein the one or more PIR sensors are coupled to a microcontroller, and wherein the one or more PIR sensors are mounted to receive infrared (IR) light through a lens; collecting, from the one or more PIR sensors, IR data, wherein the IR data comprises a time series analog signal; detecting movement, by the one or more PIR sensors, wherein the detecting is based on the collecting; sending, to a machine learning model, the IR data, wherein the machine learning model is based on a TinyML model, and wherein the TinyML model operates on the microcontroller; and classifying, by the TinyML model, one or more sources of the movement. In embodiments, the one or more sources that were classified comprise one or more humans. In embodiments, the classifying includes recognizing an activity of the one or more humans. In embodiments, the classifying includes distinguishing, by the machine learning model, one or more adults within the one or more humans. In embodiments, the classifying includes identifying, by the machine learning model, one or more children within the one or more humans.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a low power passive infrared human sensor with machine learning.

FIG. 2 is a flow diagram for classifying sources.

FIG. 3 is an infographic for a human sensor with machine learning.

FIG. 4 is a block diagram of a human sensor.

FIG. 5 is a diagram for a passive IR human sensor with machine learning.

FIG. 6 shows results from a low power passive infrared human sensor with machine learning.

FIG. 7 is a system diagram for a low power passive infrared human sensor with machine learning.

### DETAILED DESCRIPTION

Motion detection can be a necessary component in many systems. The simplest forms of motion detection can include a trip wire or pressure pad that triggers a switch closure. The switch closure, in turn, can activate downstream devices that are associated with the motion event. Other forms of motion detectors can generate a stimulus signal and sense a reflection of the stimulus energy. These are active detectors. An example of an active motion detection system can include a photocell interrupter system for which a source of illumination is incident on a photo-sensitive device. An interruption of the light energy that is incident on a photo-sensitive device can modify the electrical output of the photo-sensitive device and thereby signal a motion event. Another example of an active motion detection system that can work in the audio frequency spectrum can include an audio emitter and an audio sensor. Audio energy can be reflected back to the sensor by the presence of an object that has moved into the path. A similar detection system can be found in the marine environment in the form of sonar systems whereupon a pulse of sound is sent, and an echo can be received. A similar device can generate microwaves that are reflected back to a microwave receiving antenna. Whether audio, microwave, or another similar system, when sufficient energy is received by the sensor, a movement event can be triggered. Of higher complexity is video image processing. When a video camera captures an image that contains an illuminated object, software processing can trigger a movement event by analysis of the one or more images in succession. Yet another form of motion detection can sense natural signals generated by an object. In this type of motion detection, no stimulus energy is necessary to be generated by the device. The detection is passive. An example of this type of motion detection is a passive infrared (PIR) detector. The sensing elements within the detector can be sensitive to heat that is generated by objects in view of the detector.

Common motion detection systems can be grouped into two categories. One category includes generating a stimulus signal and sensing a reflection of the signal. The signal can include optical illumination using visible or invisible energy, electronic radiation, and so on. Practical embodiments of stimulus-reflective devices include photo-reflective or photo-interruptive apparatus, microwave circuitry with transmit-receive antennas, and cameras with lighting. A characteristic common of stimulus-reflective devices is that the stimulus can reveal the presence of the device, much like a sonar pulse can reveal the presence of a submarine. Additionally, the stimulus requires operating power. Some sensors in the stimulus-reflective category can provide a simple detection of motion, while others can yield additional information about the motion. Cameras and associated software can provide the highest magnitude of information, but the collection and processing of a video image includes the costs of power consumption, space requirements, financial expenditures, and so on.

A second category of sensors is the type that senses natural signals generated by an object. Passive infrared (PIR) sensors respond to infrared (IR) radiation that is generated by objects that have heat. IR radiation is not visible to the human eye. A PIR sensor requires no accompanying IR source. PIR sensors can detect motion depending on directional sensitivity and distance from a heat source. A PIR sensor can include one or more pairs of pyroelectric elements. The disclosed technique describes a PIR-based sensor system that contains one or more PIR detectors with motion discrimination and motion classification that runs in a low-cost microprocessor with memory-efficient machine learning firmware. The classification can include machine learning that can discriminate between human and animal motion, and between animate and inanimate motion.

Several characteristics can be true of active detection systems. Stimulus generation requires power and can add burden to the energy supply requirements and erode energy efficiency associated with a motion detection product. Stimulus energy is visible, whether to the human eye, human ear, receiving devices, and so on. In some cases, visibility is not desirable. Additionally, interrupter and reflector systems typically reveal very little information beyond the presence of motion. Video image processing can provide more information about movement sources, but adds the fiscal cost of image collection devices and sufficient computational power, plus the power cost of the added devices. Certain characteristics can be true of passive detection systems. PIR motion detectors reveal very little information beyond the presence of motion. Thus, a PIR motion detector can signal motion regardless of what caused the motion, leading to many false alarms. A PIR motion detector is unable to reveal how many people are in view or how close they are to the sensor. A PIR motion detector with a fixed lens is relegated to a fixed sweep angle and sensitivity distance. The disclosed technique can eliminate false alarms associated with PIR motion detector sensors by classifying sources of movement. Disclosures comprise a method of detecting and classifying motion events, determining if the event animate or inanimate, and triggering an alarm and communications. This is accomplished by a machine learning model that analyzes the infrared (IR) data. The machine learning model operates on a low-cost microcontroller. The machine learning model classifies the one or more sources of the motion.

The disclosed technique is a processor-implemented method for the purpose of sensing humans. One or more passive infrared (PIR) sensors can be accessed. A single PIR sensor can contain a pair of pyroelectric elements connected in a voltage-bucking configuration, so that when both elements are exposed to the same infrared (IR) energy, no output voltage will be generated. The one or more PIR sensors can be mounted in a location to receive IR energy from the locale. The PIR sensors can receive the IR energy through a lens that can customize the viewing angle to the particular application. More than one PIR sensor can be colocated at various angles to provide further movement and spatial discrimination to augment the disclosed functionality. IR data can be collected from the one or more PIR sensors as a time-series analog signal. Movement can be detected by the one or more PIR sensors by analyzing the IR data that was collected. The IR data can be sent to a machine learning model to further analyze the movement that was detected. The machine learning model can be a convolutional neural network (CNN) that can be trained with training data. The machine learning model can be based on a TinyML model that operates on a microcontroller. The TinyML model can determine the one or more sources of the movement. The TinyML model classification can discriminate one or more humans as the source of the movement. The classification can discriminate the activity of the one or more humans. The classification can further discriminate between animate movement and inanimate movement.

IR radiation can be emitted from the surface of an object. IR radiation reveals the surface temperature. IR radiation can be detected by a sensor. A passive infrared (PIR) sensor can be made of a pyroelectric material that can detect levels of IR radiation. Pyroelectricity can be understood as the ability of certain materials to generate a temporary voltage when heated or cooled. PIR detectors can be constructed with dual sensors, impedance changing semiconductors, and associated peripheral electronic devices to yield practical and measurable signals from minute changes in object heat.

A machine learning model can be used in more sophisticated motion detection systems. A machine learning model is a computer program with mathematical methods and algorithms that can recognize patterns in input data and can make predictions based on the patterns. A machine learning model can be trained with known data. The larger the known training dataset, the more accurate the training. Thereafter, when unseen data is presented to the model, patterns can be detected, and appropriate decisions can be made based on the training. Training includes optimizing the algorithm. Algorithms can include statistics, algebra, and calculus techniques. The output of the training process is called a machine learning model.

A neural network can be the underlying entity in a machine learning model. A neural network is comprised of node computational layers such as an input layer, one or more hidden layers, and an output layer. Each node can connect to another, and if activated, sends data to connected layers. A machine learning model can comprise a convolutional neural network (CNN). A convolutional neural network is one type of neural network. A CNN can be loosely modeled on the understanding of the organization of the human brain and can achieve similar performance through the process of learning from experience. A CNN has additional computational layers that increase in complexity as recognition approaches the final layer. As data progresses through the layers of the CNN, larger elements in the data object are recognized until the intended object is finally recognized. A CNN can be especially useful in image recognition and image classification.

TinyML can be a subfield of machine learning that is personalized for implementation on low-energy systems. Many low-energy systems can contain sensors, microcontrollers (MCUs), and other peripheral devices that operate in the milliwatt range. Low-power devices can be powered by batteries. Associated microcontrollers can often be resource-constrained devices with fewer input/output (I/O) pins, smaller memory sizes, slower clock speeds, and so on. TinyML can implement a lightweight, low power CNN model. Thus, latency and bandwidth of transferring data to a cloud-based large CNN model can be avoided, as well as the processing time of the large model. Because data is kept local to the edge device, data privacy can be realized, and the energy requirements can be drastically reduced as TinyML can be used on devices that are inexpensive and have resource and power constraints.

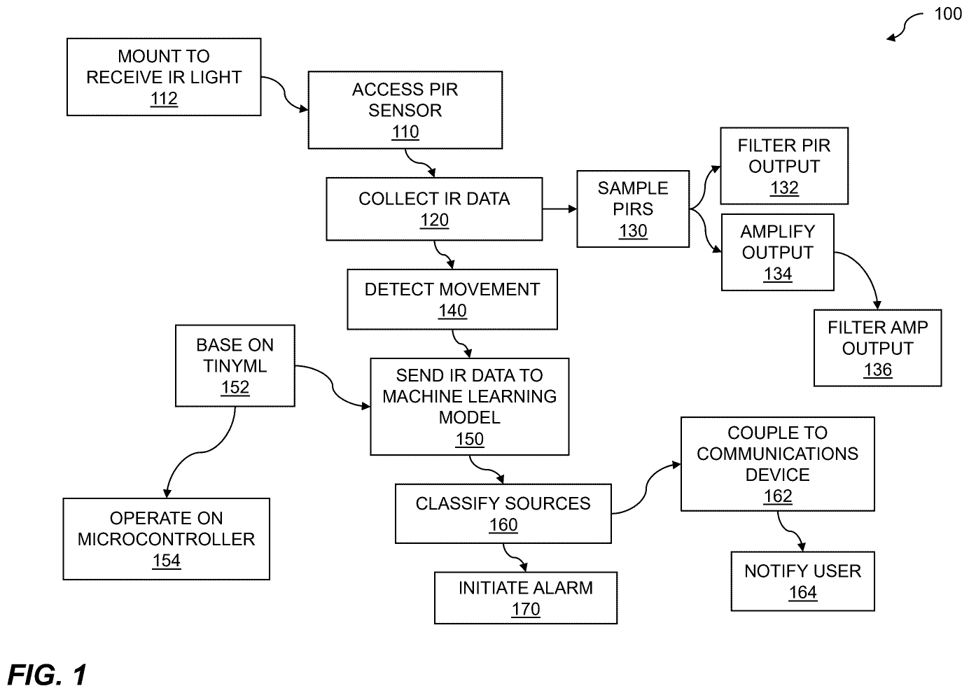

FIG. 1 is a flow diagram for a low power passive infrared human sensor with machine learning. A system contains one or more passive infrared (PIR) sensors that can be coupled to one or more filters, zero or more amplifiers, and a microcontroller. The one or more PIR sensors can be mounted so that IR radiation can be received by the one or more PIR sensors. The one or more PIR sensors can be physically arranged to view specific heights in the view of the disclosed human sensor. The one or more PIR sensors provide one or more data streams that can be filtered, and can be amplified, based on application specifics. The data streams can be sampled by the microprocessor at suitable sampling rates and collected over a time frame. The microcontroller runs a machine learning model that is based on a TinyML model. The TinyML model can be trained with training data that includes both moving and stationary data. The training data can contain a plurality of animate objects and a plurality of inanimate objects. The machine learning model can classify the source of the movement that was detected. Based on the source of the movement that was detected, the microcontroller can initiate an alarm. The microcontroller can initiate communications to a user.

The flow 100 includes accessing 110 one or more passive infrared (PIR) sensors, wherein the one or more PIR sensors are coupled to a microcontroller, and wherein the one or more PIR sensors are mounted 112 to receive infrared (IR) light through a lens. One or more PIR sensors comprise the optical sensing device in the disclosed human sensor. PIR sensors can be sensitive to IR energy. IR energy, in the frequency spectrum, has wavelengths just below the wavelength of red light. In embodiments, the IR energy is received by the one or more PIR sensors through a lens. The lens can modify the viewing angle of a PIR sensor. The IR energy can be filtered through a suitable IR filter to pass or block certain IR wavelengths depending on the application of the disclosed human sensor.

The flow 100 includes collecting 120, from the one or more PIR sensors, IR data, wherein the IR data comprises a time series analog signal. The signal output from a PIR sensor can be a time-varying waveform that is a static or dynamic waveform. The waveform can be further filtered, amplified, and routed to the microcontroller for processing. The one or more PIR sensors can be mounted to receive IR energy from a particular height or location. The view that is detected by the one PIR sensor can depend on the physical location of the sensor, the direction in which it is pointed, the lens that is installed in front of it, and so on. In embodiments, a first PIR sensor among the one or more PIR sensors can be configured to receive infrared light and movement data from a first height. In other embodiments, a second PIR sensor among the one or more PIR sensors can be configured to receive infrared light and movement data from a second height. In further embodiments, a third PIR sensor among the one or more PIR sensors can be configured to receive infrared light and movement data from a third height. The first height, the second height, and the third height can comprise a height range. The height ranges can overlap. Any height range is possible. In a usage example, the first PIR sensor can detect movement from 10 feet to 20 feet above the ground, while the second PIR sensor can detect movement from 5 feet to 15 feet above the ground, and so on. In similar ways, other heights can be detected by additional PIR sensors.

The flow 100 includes sampling 130 an output of the one or more PIR sensors, wherein the sampling is based on a sampling rate. Each of the one or more PIR sensor output waveforms can be sampled. Embodiments include filtering an output of the one or more PIR sensors 132. In other embodiments, the filtering is based on a cutoff frequency of substantially one-half of the sampling rate. As an example, a sampling rate of 50 Hz can result in a cutoff frequency of approximately 25 Hz. Other sampling rates can be selected. One or more levels of analog filters can be included between each of the one or more PIR sensors and the input to the microcontroller. The output of each of the one or more PIR sensors can be a time-varying analog signal, the magnitude and scale of which is dependent on the one or more selected PIR devices and on the application of the disclosed human sensor. The signal can be of sufficient amplitude and scale to make efficient use of the measurement input of the microcontroller. Further embodiments include amplifying 134, by an analog amplifier, an output of the one or more PIR sensors. This can be necessary if the signal is not of sufficient amplitude and scale to take advantage of the full scale of the measurement input of the microcontroller. This can also be necessary if the signal would overdrive the measurement input of the microcontroller. The amplifier function can be the same or different for each of the one or more PIR sensors. Filtering can also be performed after the amplifying 136. Thus, embodiments include filtering an output of the analog amplifier. In embodiments, the filtering is based on a cutoff frequency of substantially one-half of the sampling rate. This can apply to the filtering after the PIR sensor and/or the filtering after the amplifier.

The flow 100 includes detecting movement 140, by the one or more PIR sensors, wherein the detecting is based on the collecting. Movement that is detected by a PIR sensor can generate a time-varying waveform at the output of the PIR sensor. As described above, the time-varying waveform can be filtered and amplified (if necessary). The signal can then be routed to the measurement input of the microcontroller.

The flow 100 includes sending, to a machine learning model 150, the IR data, wherein the machine learning model is based on a TinyML model 152, and wherein the TinyML model operates on the microcontroller 154. The microcontroller can sample each of the one or more IR data waveforms from the one or more filters. The sampling can be the input to the machine learning model that operates on the microcontroller. The machine learning model can comprise a convolutional neural network, a linear regression, principal component analysis, or any other machine learning technique. The machine learning model can include one or more neural network machine learning architectures such as transformers, recurrent neural networks, long short-term memories, deep neural networks, and so on. The machine learning model can be trained with training data. The training data can include a plurality of inanimate objects, humans, animals, and so on. The training data can include moving and stationary data. The machine learning model can process the samples from the one or more filters based on the training data. In embodiments, the machine learning model is based on a TinyML model 152 which can be suited for an inexpensive, limited resource, low-power microcontroller. In embodiments, the microcontroller can consume 300 mW or less of peak power. Low power consumption of the devices can enable battery operation

The flow 100 includes classifying 160, by the TinyML model, one or more sources of the movement. One or more humans can be identified as the source of the movement. One or more children can be identified as the source of the movement. One or more animals can be identified as the source of the movement. One or more inanimate objects can be identified as the source of the movement. Classification can identify the activity of the one or more humans. The activity can be walking, running, jumping, being still, and so on. In embodiments, the machine learning model is coupled to a communications device 162. The communications device can include circuitry that broadcasts notifications on a wired network such as an internet LAN. The communications device can include circuitry that broadcasts notifications on a wireless network such as a wireless LAN, short-distance ad hoc network, cellular network, satellite network, infrared communication, and so on. Embodiments include notifying a user 164, by the communications device, wherein the notifying is based on the classifying. The machine learning model can make the decision, based on the source of the movement and the application of the disclosed human sensor, to notify a user. The notification can consist of an alarm condition, normal condition, other details associated with the classification that are pertinent to the application, and so on.

The flow 100 includes initiating an alarm 170, by the machine learning model, wherein the initiating is based on the classifying. In embodiments, the alarm comprises a light source. A light source can be integrated within the mount for the disclosed human sensor. A light source can be a standalone light source that is triggered by the disclosed human sensor. The light source can be included in the same housing as the human sensor, mounted at a separate location, etc. A light source can be an illumination device based on LED technology, CFL technology, incandescent technology, ionized gas flash technology, and so on. In other embodiments, the alarm comprises an audio alarm. An audio alarm can be integrated within the disclosed human sensor. An audio alarm can be a standalone alarm that is triggered by the disclosed human sensor mounted at a separate location. Audio alarm devices can be mounted in other locations. An audio alarm can be an electromagnetic buzzer, a piezoelectric speaker, an audio horn speaker, and so on.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

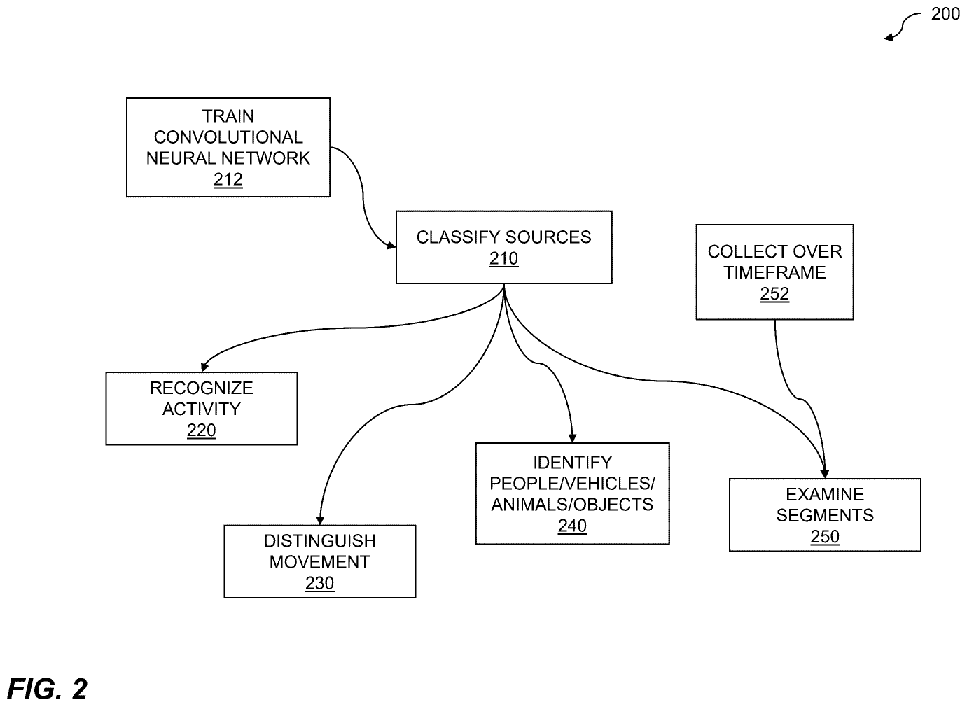

FIG. 2 is a flow diagram for classifying sources. The disclosed technique is able to sense humans using a low-cost low-power microcontroller and PIR sensors. One or more humans can be identified as the source of movement detected by the PIR sensor. One or more children can be identified as the source of the movement. One or more animals can be identified as the source of the movement. One or more inanimate objects can be identified as the source of the movement. Classification can identify the activity of the one or more humans. Desirable features of a classification system can enable speed and accuracy of the classification. A machine learning model based on TinyML can be trained with a training dataset that includes a cross-section of the movements that are expected to be detected and classified. Because a TinyML machine learning model can be implemented in a microcontroller that is integral to the device, data does not have to be sent to a computer, to the cloud, etc. Thus, the classification can be accomplished accurately, immediately, and securely and can be made available for a software application.

The flow 200 includes classifying 210, by the TinyML model, one or more sources of the detected movement. The IR data from a PIR sensor can be a time-varying waveform that is a static or dynamic waveform. The waveform can be further filtered, amplified, and/or routed to the microcontroller for processing. The TinyML machine learning model can be trained to identify patterns in input data. In embodiments, the machine learning model comprises a convolutional neural network (CNN). A CNN is a type of neural network. A neural network can be the underlying entity in a machine learning model. A neural network is comprised of node computational layers such as an input layer, one or more hidden layers, and an output layer. Each node can connect to another node, and, if activated, sends data to internally connected layers. A CNN can be loosely modeled on the understanding of the organization of the human brain and can achieve classification performance through the process of learning from training sets. A CNN can have additional computational layers that increase in complexity as recognition approaches the final layer. As data progresses through the layers of the CNN, larger elements in the data object can be recognized until the intended movement source is finally recognized based on known properties learned from the training data. The CNN can be used to classify one or more sources of movement. In embodiments, the one or more sources that were classified comprise one or more humans. In other embodiments, the one or more sources that were classified comprise one or more inanimate objects. In further embodiments, the one or more sources that were classified comprise one or more animals.

The flow 200 includes training the convolutional neural network with training data 212. Training data can be derived from a dataset that is customized for use as a data template. The training data can be developed for the intended application of the disclosed human sensor. The process of developing training data can include the collection of suitable data for the application. In embodiments, the training data includes both moving and stationary data. In a human sensor, it can be expected that objects that are detected by the human sensor can be moving or stationary. Training data can include time-varying waveform signatures, from an IR data stream, that are associated with known moving and stationary objects. In embodiments, the training data includes a plurality of humans. The training data can include time-varying waveform signatures, from an IR data stream, that are associated with humans. Among the humans, a collection of known adult humans and child humans can be included in the training data. In embodiments, the training data includes a plurality of animals. The training data can include time-varying waveform signatures, from an IR data stream, that are associated with known animals. Known animals can include one or more dogs, one or more cats, and so on. In embodiments, the training data includes a plurality of inanimate objects. A training data can include time-varying waveform signatures, from an IR data stream, that are associated with known inanimate objects. Known inanimate objects can include tree branches of various shapes and sizes, rocks of various shapes and sizes, vehicles of various shapes and sizes, and so on. The training data can ensure that the classification does not falsely detect movement of a human when a car passes by the PIR sensor. In this way, false alarms can be avoided.

The training process can include a number of sequential steps that includes data collection, data preparation including cleaning, model training, and model evaluation and tuning. The accuracy of the predictions made by the machine learning model can be based on the quality of the training data. Data collection can therefore include distinct and known models of human adults, human children, animals, inanimate objects, and so on. Data collection can also include indistinct models of human adults, human children, animals, inanimate objects, and so on. Data preparation includes the process of cleaning unwanted characteristics from the data collection. An example can be the removal of animal data from the prepared dataset that is not distinctly representative of an animal. The TinyML model can be trained with the prepared dataset. After integration into the disclosed human sensor, the TinyML model can be evaluated for accuracy in classification, and associated parameters can be iteratively adjusted as necessary.

The flow 200 includes recognizing activity 220. In embodiments, the classifying includes recognizing an activity of the one or more humans. It can be reasonably expected that a human sensor that is equipped with one or more PIR sensors can view certain angular areas at certain heights. It can also be expected that humans can be walking through that view, running through that view, standing in that view, and so on. It can be expected that a human can be advancing toward the sensor, retreating from the sensor, facing the sensor, facing away from the sensor, facing an oblique angle with respect to the sensor, and so on. Further, a human can carry something through the view that can alter the known shape of a human. More than one human can be included in the view of the disclosed human sensor. The machine learning model, with suitable training, can recognize such activity of the one or more humans.

The flow 200 includes distinguishing movement 230. In embodiments, the classifying includes distinguishing, by the machine learning model, one or more adults within the one or more humans. As explained above, it can be reasonably expected that a human sensor that is equipped with one or more PIR sensors can view certain angular areas at certain heights. Within the one or more views, the machine learning model can classify one or more human adults and one or more human children. The machine learning model can distinguish human adults within the larger collection of humans. The human adult can have relatively greater height than human children, relatively greater bulk than human children, as well as other distinguishing characteristics of human adults that are known to the machine learning model.

The flow 200 includes identifying children 240. In embodiments, the classifying includes identifying, by the machine learning model, one or more children within the one or more humans. A human sensor that is equipped with one or more PIR sensors can classify one or more people, vehicles, animals, inanimate objects, and so on. The people can be human adults and/or human children. The machine learning model can distinguish human adults and/or human children within the larger collection of humans. A human child can have a different signature in the time-varying IR signals emitted that can be classified by the machine learning model. A vehicle can likewise be distinguished from people. While vehicles are often moving, their IR signatures are are distinct from those of people. Similarly, animals can have a distinctive signature in the time-varying IR signals they emit which can be classified by the machine learning model. Furthermore, inanimate objects can also have a unique signature in the time-varying IR signals they emit which can be classified by the machine learning model, even though inanimate objects can exhibit movement, such as a branch blowing in the wind.

The flow 200 includes examining segments. In embodiments, the classifying further comprises examining 250 one or more segments of the IR data, wherein the one or more segments is collected over a timeframe 252. Recall that the IR data is a time-varying analog signal. Recall also that the IR data was collected and sampled. Each of the one or more PIR sensor output waveforms can be routed through filters, if used, and amplifiers, if used. PIR sensor output waveforms can be sampled at a sampling rate by the one or more measurement inputs in the microcontroller. The sampling rate can be accomplished by firmware or hardware control in the microcontroller, where internal clock or timing sources can be internally routed to input-gating circuitry in the microcontroller. In other embodiments, the filtering is based on a cutoff frequency of substantially one-half of the sampling rate. As an example, a sampling rate of 50 Hz can result in a cutoff frequency of approximately 25 Hz. Other sampling rates can be selected to provide a suitable level of data resolution to the TinyML machine learning model in the microcontroller. The classification can involve examining one or more samples of the IR data of each of the one or more PIR sensors. These samples of IR data can be examined over a timeframe to yield a segmented waveform or pattern. The timeframe can be any time amount such as 1 millisecond, 100 milliseconds, 1 second, 10 seconds, and so on. A pattern can be used as input to the TinyML machine learning model in the microcontroller.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

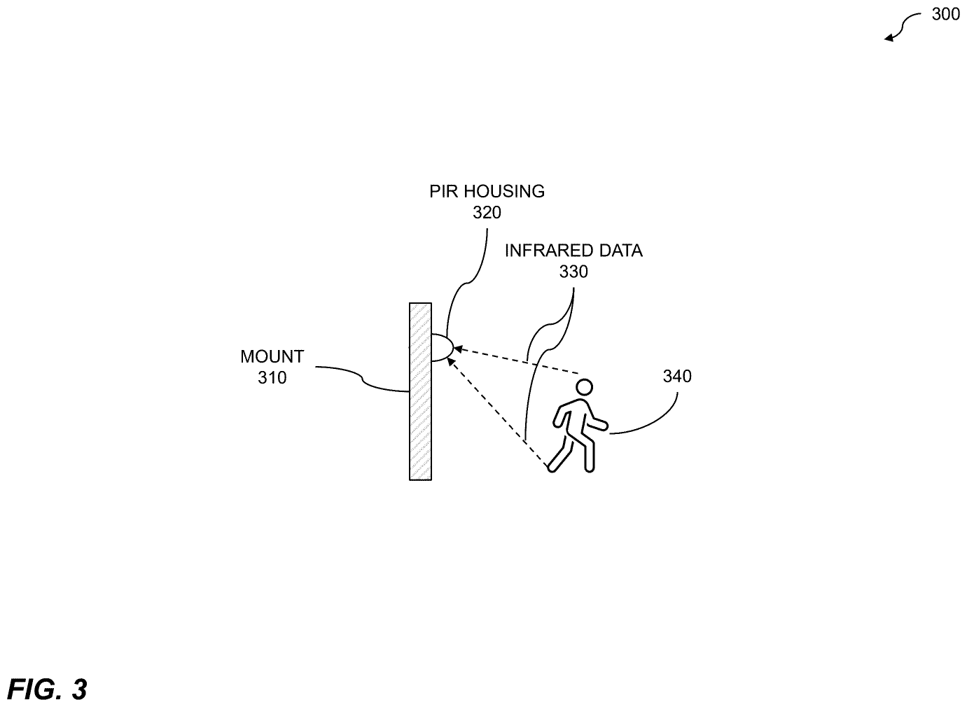

FIG. 3 is an infographic for a human sensor with machine learning. An IR-based human sensor with machine learning can be a device that is mounted to sense motion. It can contain optical elements, mechanical elements, electronic elements, and so on. It can access the sensing elements, collect the sensed data, detect movement from the data, and classify the source of movement. A human sensor can be used to detect humans on a sidewalk, in a driveway, at a machine tool in an industrial establishment, in the cockpit of an airplane, in the cab of a railroad locomotive, and so on. The output of a human sensor can be used in a security application and can activate an alarm when humans are detected in secure locations. The output of a human sensor can be used in a safety application and can activate an alarm when humans are detected in an unsafe scenario. The output of a human sensor can be used in a confirmation application and can activate an alarm when humans are not performing intended tasks. The output of a human sensor can be used in various other applications. Furthermore, the human sensor can distinguish between a human and an animal. Thus, the person sensor can be used to prevent false alarms due to animal movement or movement on an inanimate object. This is not possible with a standard PIR sensor without human sensing.

The infographic 300 includes a mount 310. In embodiments, one or more PIR sensors are mounted to receive infrared (IR) light through a lens. A PIR sensor is an optical device that must have a clear view of the intended target area. Any number of humans, animals, or inanimate objects can be within the target area. The target area can span a horizontal angle and a vertical angle as viewed from the location of the PIR sensor and lens. As an example, a PIR sensor can be installed in an overhead location above a sidewalk to sense IR energy originating from the space on and around the sidewalk. As another example, a PIR sensor can be installed inside a building in a hallway to sense IR energy emitted by objects in the hallway. Attention can be given to selecting and mounting a human sensor to help discriminate desired from undesirable activity in view of the sensor.

The infographic 300 includes a housing 320. Embodiments include one or more passive infrared (PIR) sensors located in a housing. A housing can provide a plurality of functions such as physical damage protection to the disclosed human sensor, environmental protection, thermal insulation, optical isolation, a mounting mechanism, and so on. A housing can be fabricated from various materials that are deemed suitable for the application of the disclosed human sensor. Materials can be metallic and non-metallic. Metallic materials can include steel, stainless steel, aluminum, and other metals or alloys. Metallic materials can provide a relatively resilient casing that can protect internal components from mechanical shock, nearby lightning strikes, physical damage from nearby structures, and so on. A metallic housing can afford a level of tamper resistance. Non-metallic materials can include plastics, organic materials, and so on. Plastic housings can be made of polyvinyl chloride (PVC), polyethylene terephthalate glycol (PETG), nylon, and other materials that can be selected and suited to the application of the disclosed human sensor.

The infographic 300 includes infrared data 330. IR data can be collected by the one or more PIR sensors. IR data can include useful data or unwanted data. Unwanted data can interfere with accuracy of classification of movement sources. A multiplicity of viewing heights and angles can serve as a pre-filter to rule in or rule out certain sources of motion depending on the intended application of the disclosed human sensor. The IR data can provide data patterns that are recognizable to the TinyML machine learning model that operates in the microcontroller in the disclosed human sensor.

The infographic 300 includes a source of motion 340. Animate objects and some inanimate objects emit levels of IR energy. IR data can reveal a surface temperature of the animate or inanimate object. Animate objects and inanimate objects can be stationary while they emit IR energy. Animate objects and inanimate objects can be moving and can emit IR energy. Stationary and moving IR energy can be sensed by the one or more PIR sensors in the disclosed technique. In embodiments, the IR data comprises a time series analog signal. The time series analog signal can be based on a stationary or moving object. The signal output from a PIR sensor can be a time-varying waveform that is a static or dynamic waveform. The waveform can be further filtered, amplified, and routed to the microcontroller in the housing 320 for processing and classification by the machine learning model.

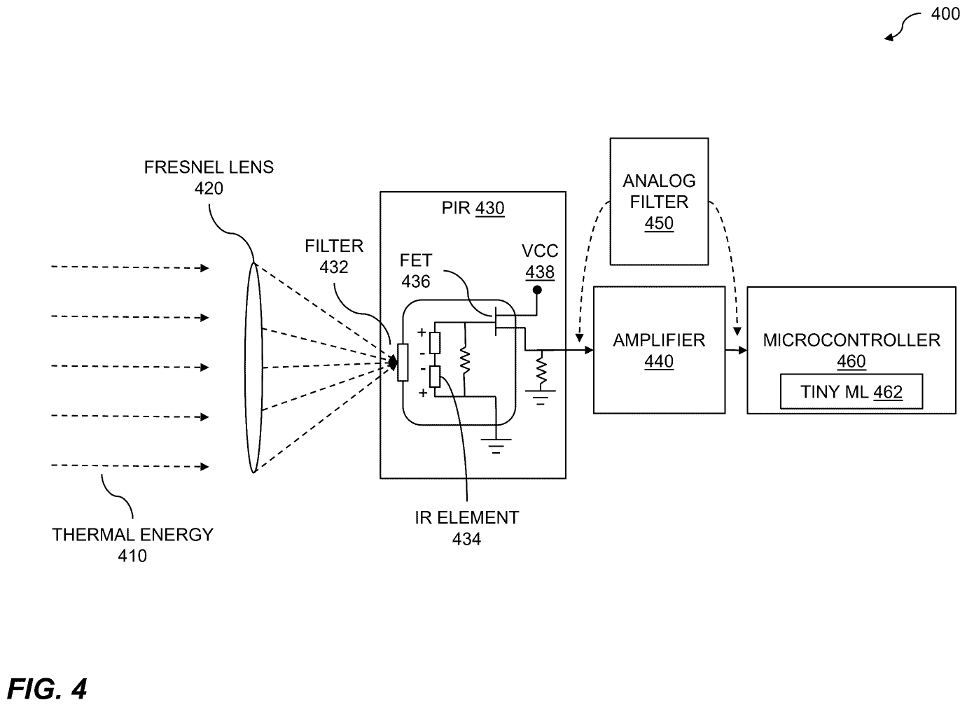

FIG. 4 is a block diagram of a human sensor. This diagram illustrates the main components of the disclosed human sensor that can reside within a housing. These main components can convert patterns of sensed thermal energy into classifications of movement sources. The diagram 400 includes collecting thermal energy 410. In embodiments, the collecting is based on infrared radiation emitted from the one or more sources of the movement. In other embodiments, the collecting is based on infrared radiation reflected from the one or more sources of the movement. Thermal energy in an object in nature has wavelengths just below the wavelength of red light. While thermal energy can be considered optical energy, it is not visible to the human eye. Thermal energy can be sensed by the human as heat. Thermal energy can be generated by a source object or reflected from the source object by another object. Thermal energy received directly from a source object can reveal the surface temperature of that object. Thermal energy received by reflection from a source object can reveal the surface temperature of the reflecting object.

The diagram 400 includes a Fresnel lens 420. A lens can be an optical device that concentrates optical patterns of an image. The disclosed human sensor can have a lens that concentrates a relatively wide arc in two dimensions into a relatively narrow area over a PIR sensor. In embodiments, the lens comprises a Fresnel lens. A Fresnel lens differs from a conventional lens by being divided into a set of lens-like sections. A Fresnel lens can be a spherical type that focuses optical energy at a single spot. A Fresnel lens can be a cylindrical type that focuses optical energy in a single line, a spot type that focuses optical energy at a single non-concentrated spot, a linear type that focuses optical energy into a narrow non-concentrated band, and so on. A Fresnel lens can be made thinner than a conventional lens, and thereby can reduce material bulk and cost of a conventional lens. A Fresnel lens can provide a relatively short focal length without the material volume requirements of a conventional lens. The reduction of image quality by the discontinuities created by the individual sections of the Fresnel lens can have minimal impact in the PIR optics in the disclosed human sensor.

The diagram 400 includes a passive IR (PIR) 430 assembly that is comprised of several elements that include an IR input filter 432, an IR element 434, a field-effect transistor (FET) 436, a power connection VCC 438, and so on. PIR sensors are sensitive to IR energy. IR energy, in the frequency spectrum, has wavelengths just below the wavelength of visible red light. The IR energy can be filtered through a suitable IR filter. An IR filter can pass or reject certain IR wavelengths depending on the application of the disclosed human sensor. An IR filter can prevent visible light from entering the housing and affecting IR sensitive areas of the disclosed human sensor. The disclosed technique can employ a dual element PIR sensor. A PIR element can be fabricated with a pyroelectric material. Pyroelectricity can be understood as the ability of certain materials to generate a temporary voltage when heated or cooled. The hotter an object is, the more IR radiation is emitted. In embodiments, the one or more PIR sensors comprise a differentially opposed PIR sensor. A dual-element element PIR sensor contains two pyroelectric elements connected in a voltage-bucking configuration so that when both elements are exposed to the same IR energy, no output voltage will be generated. If the two elements are exposed to differing levels of IR energy, the output can be positive or negative for a time duration. A PIR element can be understood as a current source in parallel with a capacitance. The output of the dual element PIR sensor can therefore exhibit a very high electrical impedance. The dual element PIR sensor can be affected by losses such as charge leakage, downstream circuit characteristics, and so on. A high-value load resistor is illustrated and is used to convert the current to a voltage. A field effect transistor (FET) can be employed to isolate the resulting voltage from downstream circuitry characteristics. A suitable FET will exhibit low-noise and low-leakage characteristics. The FET 436 requires a VCC power connection for operation as a high-to-low impedance converter to sufficiently drive any downstream filters and amplifiers. The power connection can come from an external power source. The power source can exist within the PIR sensor housing or elsewhere. The VCC is illustrated as connected to the FET drain pin. The output of the FET is at its source pin, and a source resistor is illustrated as the load.

The diagram 400 includes an amplifier 440. Embodiments include amplifying, by an analog amplifier, an output of the one or more PIR sensors. An amplifier can be used if the pyroelectric voltage response is not of sufficient amplitude to be useful as input to a downstream microcontroller measurement input. Amplitude can be scaled by the amplifier to take full advantage of the bit-resolution of the measurement input of the microcontroller or other measurement mechanism. As an example, if the measurement input of the microcontroller or other measurement mechanism is a 12-bit input with a 3.3V reference voltage, and the amplitude of the PIR sensor is a maximum of 0.1V, the digital accuracy of the PIR sensor output can be barely seven bits. Other bit widths and reference voltages can be employed to maximize the ultimate analysis by the TinyML machine learning model (described above and throughout) and enhance accuracy of classification.

The diagram 400 includes an analog filter 450. The filtering function can be accomplished by the sampling. Collected IR data can be converted to digital signals through a process called sampling. Sampling can measure and convert a signal to a discrete number value for a segment of time. The sampling rate can be the number of discrete measurements per second that are completed. The Nyquist-Shannon sampling theorem links continuous time-varying signals to a discrete set of samples, where minimal loss of input information is possible if the sampling rate is at least twice the bandwidth of the input signal. Embodiments include filtering an output of the one or more PIR sensors. Other embodiments include filtering an output of the analog amplifier. In embodiments, the filtering is based on a cutoff frequency of substantially one-half of the sampling rate. Additional filtering can be provided by analog filters that can be implemented with physical components. This can be necessary for the purposes of pre-filtering unwanted signal bandwidths that can reduce the subsequent processing load on the TinyML machine learning model.

The diagram 400 includes a microcontroller 460. Low-energy systems such as the disclosed human sensor can contain sensors, microcontrollers, and other peripheral devices that operate in the milliwatt range. Low-power devices often can be powered by batteries. Batteries can include nickel-metal hydride (NIM H) batteries, lithium-ion-polymer (LiPo) batteries, and other battery types. Suitable battery characteristics can include shelf-life duration, recharge capability, and so on. Some microcontrollers can operate for a sufficient duration on battery power. Microcontrollers, in contrast to microprocessors, can often be resource-constrained devices with fewer input/output (I/O) pins, smaller memory sizes, slower clock speeds, and so on. Microcontrollers can include processors that are based on the ARM Cortex-M series architecture, the ESP32 series of system-on-a-chip (SOC) architecture with one or more cores, and so on. The microcontroller can accomplish tasks such as sampling the one or more PIRs, running the machine learning model, alarm functions, communications device management and user notifications, power management including sleep modes, battery management and alerts, bootup tasks, fault detection and watchdog resets, environmental management within the housing, and so on.

There is a plurality of methods for measuring samples of waveforms by a microcontroller, including employing an external analog-to-digital converter (ADC), using an internal ADC, and others. Direct resources in the microcontroller that can include one or more ADC inputs can be used. One or more ADC inputs can be routed to one or more discrete ADC elements within the microcontroller. One or more ADC inputs can be internally multiplexed to fewer ADC elements within the microcontroller. An ADC can be commanded to initiate a single measurement or a continuous measurement of waveform voltage. The one or more ADC inputs in a microcontroller can have embedded sample-and-hold circuitry connected to the physical input pins. Sample-and-hold circuitry can consist of a field-effect transistor (FET) series analog switch between the input pin and the ADC element. Sample-and-hold circuitry can also include a hold capacitor connected between the input to the ADC element and the common voltage rail, usually ground, that holds an impressed voltage level for a brief duration. Sampling an input by the microcontroller can consist of activating the FET analog switch for a brief duration to charge the hold capacitor, deactivating the analog switch, initiating an ADC measurement of the voltage on the hold capacitor, and so on. ADC speed and multiplexed sharing can be factors in the selection of a suitable microcontroller that can maintain the selected sampling rate.

Realistic compromises can be considered in the design of a product that uses sampling in a microcontroller. The finite capacitance of the hold capacitor can require a time duration to fully charge to the input voltage through the finite non-zero resistance of the FET analog switch. Source impedance of the circuitry that feeds the ADC input contributes added resistance that can make the time duration longer. Accurate waveform measurement and sampling rate can therefore be limited by the external and internal input circuitry to the ADC element. There are various methods to mitigate the effect that can include added capacitance at the physical input pin, lowering the drive impedance of the PIR output circuitry, and so on. Analog filters can be a factor in the drive impedance of the PIR output circuitry that can influence the design of the disclosed human sensor.

A significant element in the disclosed human sensor that operates on the microcontroller is the TinyML 462 machine learning model. TinyML can be a subset of machine learning models that is personalized for implementation on low-energy systems. Because TinyML machine learning can be accomplished in a microcontroller that is part of the edge device, the output can be immediately available and applied in the system application. The latency and bandwidth of data transfer and processing on a remote server is thereby avoided. Because data is kept local to the edge device, data privacy can be realized, and the energy requirements of data transmission can be reduced. TinyML can be used on devices that are inexpensive and have resource and power constraints. TinyML can be used in devices that spot gestures, recognize objects, identify sounds and phrases, monitor machines, and so on. TinyML is used in the disclosed human sensor for the recognition and classification of sources of detected movement and can initiate subsequent alarms and communications. The TinyML machine learning model can be trained with training data. The training can include unsupervised self-learning, parameter enhancement, and so on. The training can also include supervised learning and parameter enhancement after deployment of the disclosed human sensor.

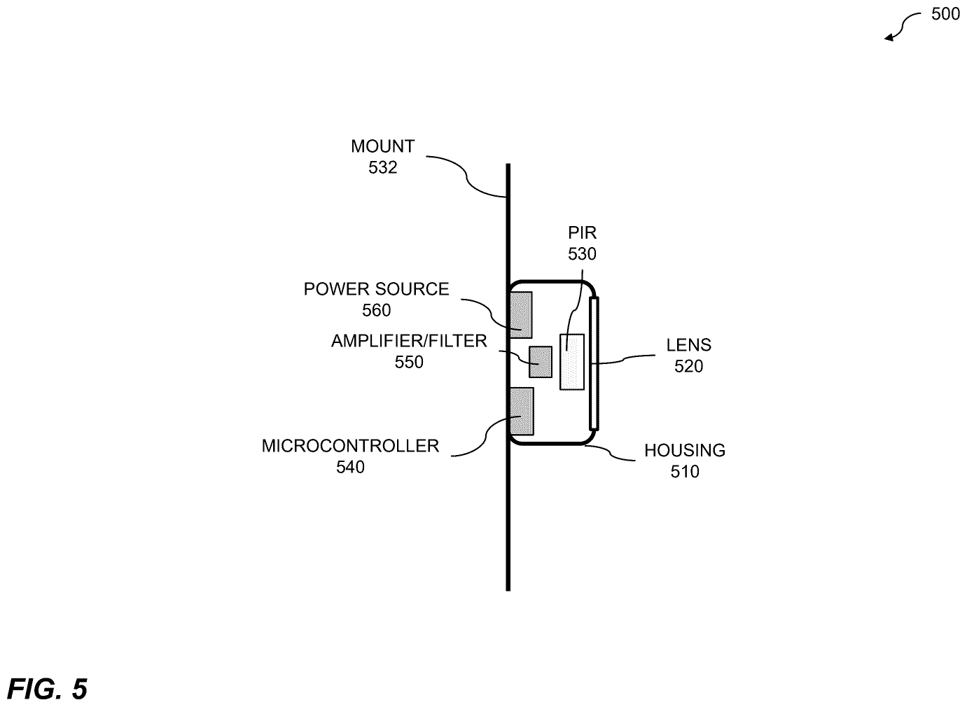

FIG. 5 is a diagram for a passive IR human sensor with machine learning. Illustrated within the housing are the significant physical components of the disclosed human sensor that include the lens, the one or more PIR sensors, the amplifier, and filters, the microcontroller, the power source, and so on. Alarm hardware and communications devices can reside in the housing, outside the housing, or at a remote location, if used. The housing is mounted in a suitable location to perform the intended application functions of the disclosed human sensor. Intended functions include the control of outdoor lighting based on detected and classified movement within the PIR viewing range; the control of interior building lighting depending on occupancy; the control of machinery and protection of operators; the control of other mechanisms that depend on accurate sensing of humans, animals, and inanimate objects; and so on. Embodiments include an apparatus for a low power passive infrared human sensor with machine learning.

The diagram 500 includes a housing 510. Embodiments include one or more passive infrared (PIR) sensors located in a housing, wherein the one or more PIR sensors 530 are mounted to receive infrared (IR) light through a lens. The housing 510 can provide a plurality of functions. A housing can provide physical protection to the disclosed human sensor such as the prevention of vandalism or damage from moving objects. In addition, a housing can provide environmental protection such as prevention of moisture ingress, thermal insulation to maintain a specific internal temperature, and so on. A housing can also provide optical insulation to prevent visible light from entering IR sensitive areas of the disclosed human sensor. The housing can provide the mounting mechanism for the lens, PIR sensors, filters and amplifiers, microcontroller, power supply, connectors, communications equipment, cables, and so on.

The diagram 500 includes a lens 520. Recall that the lens can be a Fresnel lens. The Fresnel lens can be supported at the right focal distance from the one or more PIR sensors. The lens support can be inflexible and stiff to avoid the introduction of electrical perturbations due to unwanted movement of mechanical structures that support the lens and the one or more PIR sensors. IR energy can be filtered through a suitable IR filter, and can be positioned before or after the lens to pass or block certain IR wavelengths depending on the application of the disclosed human sensor. The lens itself can be made of the suitable filter material. The lens can be fabricated from a suitable material such as glass, plastic, and so on. The lens can be fabricated of a material that is resilient to purposeful or inadvertent physical damage. The lens can be fabricated of a material that is resilient to long-term exposure to IR energy, ultra-violet (UV) energy, and other energy that can damage it and reduce its functionality.

The diagram 500 includes a PIR sensor 530. The one or more PIR sensors can include a dual IR element. The one or more PIR sensors can be sensitive to IR energy. IR energy, in the frequency spectrum, has wavelengths just below the wavelength of red light. The role of the one or more PIR sensors can be to receive thermal energy and provide a time-varying output voltage that is related to moving objects with a view of the one or more PIR sensors. The PIR sensors can be mounted on a mount 532 to view one or more heights. The housing 510 can be mounted where the PIR sensors 530 and lens 520 have a view of the desired area in which to detect movement. The housing 510 can be mounted in such a way as to avoid detection of movement in certain areas. An example of unwanted movement can be vehicular traffic on a roadway or pedestrian traffic on a sidewalk, when all that is desired is the detection of movement in the driveway. Another example of unwanted movement can be occupants in a hallway at the intersection of another hallway when the motion of interest pertains to only one of the hallways.

The diagram 500 includes a microcontroller 540. Embodiments include a microcontroller, wherein the microcontroller hosts a convolutional neural network (CNN), and wherein the CNN is based on a TinyML model. Recall that low-energy systems such as the disclosed human sensor can contain sensors, microcontrollers, and other peripheral devices that operate in the milliwatt range. Microcontrollers or SOC microcontrollers, in contrast to microprocessors, can be well suited to running a CNN based on a TinyML model. In particular, the disclosed human sensor is an application that needs few I/O pins and a relatively large embedded memory structure.

The diagram 500 includes an amplifier/filter 550. Embodiments include an analog amplifier, wherein the analog amplifier amplifies an output of the one or more PIR sensors. Output waveform amplitude can be scaled by the amplifier to take full advantage of the bit-resolution of the measurement input of the microcontroller or other measurement mechanism. Coupled with the amplifier can be one or more filters. Filters can be implemented as circuitry components that form analog filters, or the filtering function can be accomplished by the sampling. Collected IR data can be converted to digital signals through a sampling process.

The diagram 500 includes a power source 560. Recall that the high-to-low impedance conversion FET, as well as other circuitry, requires a VCC power supply. Power can be transferred into the housing by means of cables, solar energy, inductive coupling, or other means. Hermiticity can be a factor in the selection of power transfer mechanism depending on the application of the disclosed human sensor. Power that is conveyed to the inside of the enclosure can be transformed to the required one or more voltages. Power can supply electronic circuitry, communication signaling devices, alarm devices, housing heating and cooling devices, and so on. Power can be loosely regulated, such as that required for the operation of an alarm. Recall that an alarm can be a light source or audio alarm. Power can be normally regulated, such as that which is required for the operation of digital circuitry such as the microcontroller. Power can be tightly regulated, such as can be required to operate noise sensitive components in proximity to the PIR sensors, as well as analog circuitry associated with filters and low-noise amplifiers. Power regulation can be done by switch-mode power supplies or linear power supplies, depending on electrical efficiency requirements and electrical noise requirements of the circuitry in the housing. The power supply can be a battery. The power supply can include a transformer to convert AC power from an external source to DC power required by the components.

In embodiments, the components of diagram comprise an apparatus for sensing humans comprising: one or more passive infrared (PIR) sensors located in a housing, wherein the one or more PIR sensors are mounted to receive infrared (IR) light through a lens; a microcontroller, wherein the microcontroller hosts a convolutional neural network (CNN), and wherein the CNN is based on a TinyML model; an analog amplifier, wherein the analog amplifier amplifies an output of the one or more PIR sensors; and a power source, wherein the power source is coupled to provide power to the one or more PIR sensors, the microcontroller, and the analog amplifier, and wherein the power source is contained within, on, or next to the housing. In embodiments, the one or more PIR sensors and the microcontroller that hosts the convolutional neural network are used to classify one or more sources of a movement. In further embodiments, the one or more sources of the movement that were classified comprise one or more humans.

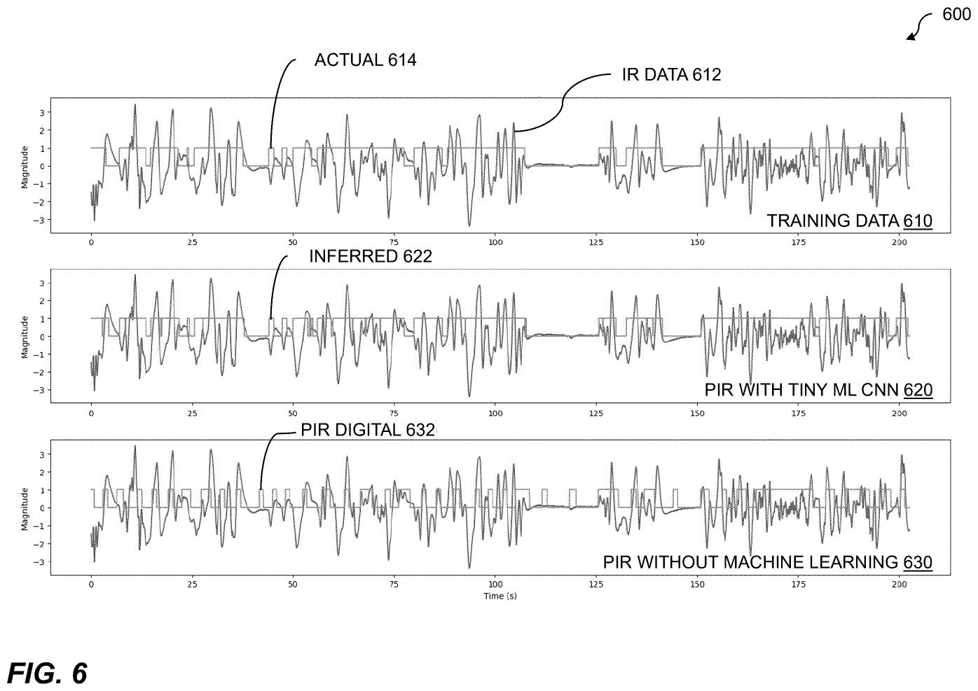

FIG. 6 shows results from a low power passive infrared human sensor with machine learning. These results can reveal the level of detection accuracy that is afforded by the disclosed human sensor, particularly by the TinyML machine learning model that runs in its microcontroller. The results 600 include training data 610. Recall that IR data is an analog time-varying waveform received from a PIR sensor. IR data 612, based on physical PIR-based hardware, was collected and stored as training data. The training data was correlated with the actual 614 detected and classified movements that generated the IR data. The training data was processed by a CNN, and a TinyML machine learning model was generated based on the training data. The TinyML machine learning model was embedded in the disclosed human sensor hardware.

The results 600 include data output from a PIR sensor with a TinyML CNN 620. The same physical movements that generated the IR data 612 that was used to train the TinyML machine learning model was also used as input to the PIR sensor with a TinyML CNN 620. The output of the machine learning model was based on the evidence and computational reasoning built into the machine learning model. It can be observed that the inferred movement results 622 which detected and classified the movement correlates well with the actual 614 movement in the training data.

The results 600 include an example PIR data without machine learning 630. The same physical movements that generated the IR data that was used to generate the TinyML machine learning model was also used as input to the PIR sensor without machine learning 630. It can be observed that the inferred PIR digital 632 output has numerous false detections and does not correlate well at numerous places with the actual 614 movement waveform.

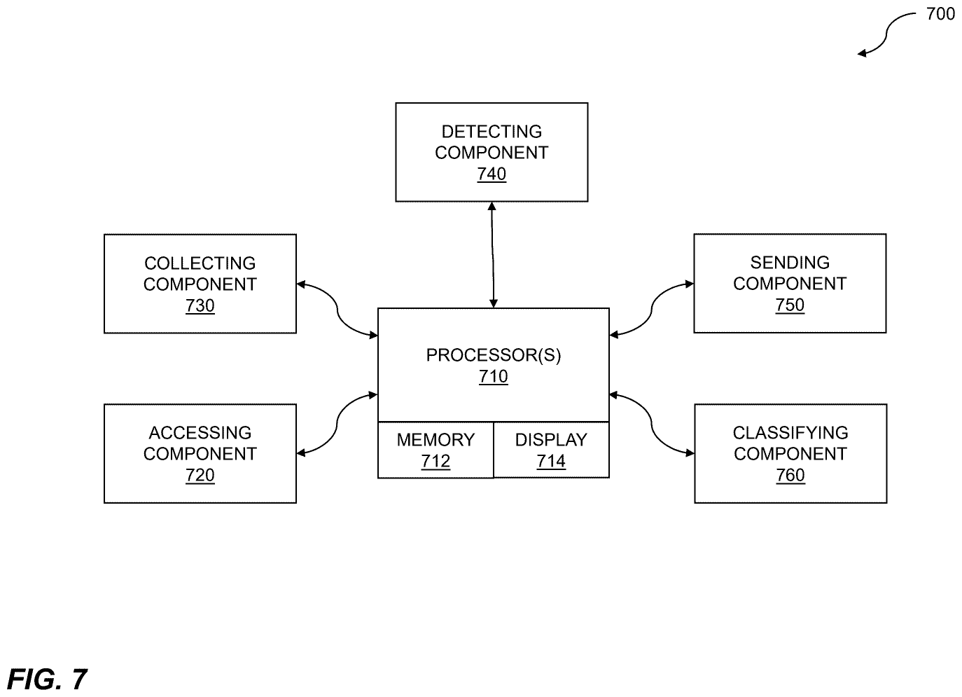

FIG. 7 is a system diagram for a low power passive infrared human sensor with machine learning. The disclosed human sensor is aimed at being a low-cost, low-complexity, and powerful system for the detection and classification of movements within its optical view. The system can initiate subsequent alarms and notifications based on the classification.

The system 700 includes a processor 710. A processor can comprise one or more processors or processor cores. Processor cores or processors can include microprocessors, microcontrollers, system-on-chip (SOC) devices, and so on. Cores can be embedded in application specific integrated circuits (ASICs). Cores can be embedded as soft cores in field programmable gate array (FPGA) products. Other types of microcontrollers can be utilized, and more than one type of microcontroller can be utilized in the disclosed human sensor. Low cost and low power consumption can be factors in the selection of the processor. The one or more processors 710 can be coupled to a memory 712. Memories can be one or more storage devices that include volatile and non-volatile semiconductor memories, cache memory structures, main memory, and other types of local memory. Memories can be embedded within the microcontroller or can be external to the microcontroller. The one or more processors 710 can be coupled to a display 714. The one or more processors 710 can be coupled to human interface devices (HIDs) via a communications device that can include a wireless network such as a wireless LAN, short-distance ad hoc network, cellular network, satellite network, infrared communication, and so on. The one or more processors 710 can be connected to human interface devices (HIDs) via a wired device such as a keyboard and display. The disclosed human sensor can contain sensors, microcontrollers, and other peripheral devices that operate in the milliwatt range. Low-power devices often can be powered by batteries. Microcontrollers can include processors that are based on the ARM Cortex-M™ series architecture, the ESP32™ series of system-on-a-chip (SOC) architecture with one or more cores, a RISC-V™ SOC architecture, and so on. The microcontroller can accomplish tasks such as sampling the one or more PIRs, running the machine learning model, alarm functions, communications device management and user notifications, power management including sleep modes, battery management and alerts, bootup tasks, fault detection and watchdog resets, environmental management within the housing, and so on. A suitable microcontroller can run at a speed where there is little perceived latency in machine learning computations and results.

The system 700 includes an accessing component 720. Embodiments include accessing one or more passive infrared (PIR) sensors, wherein the one or more PIR sensors are coupled to a microcontroller, and wherein the one or more PIR sensors are mounted to receive infrared (IR) light through a lens. One or more PIR sensors include the optical sensing device in the disclosed human sensor. PIR sensors can be sensitive to IR energy. IR energy, in the frequency spectrum, has wavelengths just below the wavelength of red light. In embodiments, the IR energy is received by the one or more PIR sensors through a lens. The lens can modify the viewing angle of a PIR sensor. The IR energy can be filtered through a suitable IR filter to pass or block certain IR wavelengths, depending on the application of the disclosed human sensor.

The system 700 includes a collecting component 730. The collecting component collects, from the one or more PIR sensors, IR data. If there is one PIR sensor, it can be mounted to receive IR energy from a particular location. The view that is detected by the one PIR sensor can depend on the physical location of the sensor, the direction in which it is pointed, and the lens that is installed in front of it. The one or more PIR sensors, in embodiments, can be configured to receive infrared light and movement data from a first height. The one or more PIR sensors, in embodiments, can be configured to receive infrared light and movement data from a second height. The one or more PIR sensors, in embodiments, can be configured to receive infrared light and movement data from a third height. In similar ways, other heights can be viewed by additional PIR sensors. In embodiments, the IR data comprises a time series analog signal. The signal output from a PIR sensor can be a time-varying waveform that is a static or dynamic waveform. The waveform can be further filtered, amplified, and routed to the microcontroller for processing. The system 700 includes sampling an output of the one or more PIR sensors, wherein the sampling is based on a sampling rate. Each of the one or more PIR sensor output waveforms can be sampled. Embodiments include filtering an output of the one or more PIR sensors. In other embodiments, the filtering is based on a cutoff frequency of substantially one-half of the sampling rate. As an example, a sampling rate of 50 Hz can result in a cutoff frequency of approximately 25 Hz. Other sampling rates can be selected. One or more levels of analog filters can be included between each of the one or more PIR sensors and the input to the microcontroller. The output of each of the one or more PIR sensors is a time-varying analog signal whose magnitude and scale is dependent on the one or more selected PIR devices and on the application of the disclosed human sensor. The signal can be of sufficient amplitude and scale to make efficient use of the measurement input of the microcontroller. Further embodiments include amplifying, by an analog amplifier, an output of the one or more PIR sensors. This can be necessary if the signal is not of sufficient amplitude and scale to be suitable for the measurement input of the microcontroller. This can also be necessary if the signal would overdrive the measurement input of the microcontroller. There can be one amplifier function associated with each of the one or more PIR sensors. Embodiments include filtering an output of the analog amplifier. In other embodiments, the filtering is based on a cutoff frequency of substantially one-half of the sampling rate. A sampling rate of 50 Hz can result in a cutoff frequency of approximately 25 Hz. Other sampling rates can be selected. One or more levels of analog filters can be included between each of the one or more amplifiers and the measurement input of the microcontroller.

The system 700 includes a detecting component 740. Embodiments include detecting movement, by the one or more PIR sensors, wherein the detecting is based on the collecting. Movement that is detected by a PIR sensor can generate a time-varying waveform at the output of the PIR sensor. Movement that is detected by the PIR sensor, of the one or more PIR sensors, that is configured for the first height can be filtered, and can be amplified and routed to the measurement input of the microprocessor or other measuring device. Movement that is detected by the PIR sensor, of the one or more PIR sensors, that is configured for the second height can be filtered, and can be amplified and routed to the measurement input of the microprocessor or other measuring device. Movement that is detected by the PIR sensor, of the one or more PIR sensors, that is configured for the third height can be filtered, and can be amplified and routed to the measurement input of the microprocessor or other measuring device.

The system 700 includes a sending component 750. Embodiments include sending, to a machine learning model, the IR data, wherein the machine learning model is based on a TinyML model, and wherein the TinyML model operates on the microcontroller. The microcontroller samples each of the one or more IR data waveforms from the one or more filters. The samples can be the input to the machine learning model that operates on the microcontroller. The machine learning model contains algorithms that were created by training data during manufacture of the disclosed human sensor. The machine learning model can process the samples from the one or more filters based on the training data. The machine learning model is based on a TinyML model which can be suited for an inexpensive, limited resource, low-power microcontroller. The microcontroller can consume less than 100 mW peak power. Some applications can allow power consumptions that are low enough for a microcontroller to operate for a sufficient duration on battery power.

The system 700 includes a classifying component 760. Embodiments include classifying, by the TinyML model, one or more sources of the movement. One or more humans can be identified as the source of the movement. One or more children can be identified as the source of the movement. One or more animals can be identified as the source of the movement. One or more inanimate objects can be identified as the source of the movement. Classification can identify the activity of the one or more humans. In embodiments, the machine learning model is coupled to a communications device. The communications device can include circuitry that broadcasts notifications on a wired network such as an internet LAN. The communications device can include circuitry that broadcasts notifications on a wireless network such as a wireless LAN, a short-distance ad hoc network, a cellular network, a satellite network, infrared communication, and so on. Embodiments include notifying a user, by the communications device, wherein the notifying is based on the classifying. The machine learning model can make the decision, based on the source of the movement and the application of the disclosed human sensor, to notify a user. The notification can consist of an alarm condition, normal condition, other details associated with the classification that are pertinent to the application, and so on.

The system 700 includes a computer program product embodied in a non-transitory computer readable medium for sensing humans, the computer program product comprising code which causes one or more processors to generate semiconductor logic for: accessing one or more passive infrared (PIR) sensors, wherein the one or more PIR sensors are coupled to a microcontroller, and wherein the one or more PIR sensors are mounted to receive infrared (IR) light through a lens; collecting, from the one or more PIR sensors, IR data, wherein the IR data comprises a time series analog signal; detecting movement, by the one or more PIR sensors, wherein the detecting is based on the collecting; sending, to a machine learning model, the IR data, wherein the machine learning model is based on a TinyML model, and wherein the TinyML model operates on the microcontroller; and classifying, by the TinyML model, one or more sources of the movement.

The system 700 includes a computer system for sensing humans comprising: an external memory which stores instructions; one or more processors coupled to the external memory, wherein the one or more processors, when executing the instructions which are stored, are configured to: access one or more passive infrared (PIR) sensors, wherein the one or more PIR sensors are coupled to a microcontroller, and wherein the one or more PIR sensors are mounted to receive infrared (IR) light through a lens; collect, from the one or more PIR sensors, IR data, wherein the IR data comprises a time series analog signal; detect movement, by the one or more PIR sensors, wherein the detecting is based on the collecting; send, to a machine learning model, the IR data, wherein the machine learning model is based on a TinyML model, and wherein the TinyML model operates on the microcontroller; and classify, by the TinyML model, one or more sources of the movement.

The system 700 includes an apparatus for sensing humans comprising: one or more passive infrared (PIR) sensors located in a housing, wherein the one or more PIR sensors is mounted to receive infrared (IR) light through a lens; a microcontroller, wherein the microcontroller hosts a convolutional neural network (CNN), and wherein the CNN is based on a TinyML model; an analog amplifier, wherein the analog amplifier amplifies an output of the one or more PIR sensors; and a power source, wherein the power source is coupled to provide power to the one or more PIR sensors, the microcontroller, and the analog amplifier, and wherein the power source is contained within, on, or next to the housing. In embodiments, the one or more PIR sensors and the microcontroller that hosts the convolutional neural network are used to classify one or more sources of a movement. In other embodiments, the one or more sources of the movement that was classified comprises one or more humans

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for sensing humans comprising:
accessing one or more passive infrared (PIR) sensors, wherein the one or more PIR sensors are coupled to a microcontroller, and wherein the one or more PIR sensors are mounted to receive infrared (IR) light through a lens;
collecting, from the one or more PIR sensors, IR data, wherein the IR data comprises a time series analog signal;
detecting movement, by the one or more PIR sensors, wherein the detecting is based on the collecting;
sending, to a machine learning model, the IR data, wherein the machine learning model is based on a TinyML model, and wherein the TinyML model operates on the microcontroller; and
classifying, by the TinyML model, one or more sources of the movement.

2. The method of claim 1 wherein the one or more sources that were classified comprise one or more humans.

3. The method of claim 2 wherein the classifying includes recognizing an activity of the one or more humans.

4. The method of claim 1 wherein the one or more sources that were classified comprise one or more inanimate objects.

5. The method of claim 1 wherein the one or more sources that were classified comprise one or more animals.

6. The method of claim 1 further comprising sampling an output of the one or more PIR sensors, wherein the sampling is based on a sampling rate.

7. The method of claim 6 further comprising filtering the output of the one or more PIR sensors.

8. The method of claim 7 wherein the filtering is based on a cutoff frequency of substantially one-half of the sampling rate.

9. The method of claim 6 further comprising amplifying, by an analog amplifier, the output of the one or more PIR sensors.

10. The method of claim 9 further comprising filtering an output of the analog amplifier.

11. The method of claim 10 wherein the filtering is based on a cutoff frequency of substantially one-half of the sampling rate.

12. The method of claim 1 wherein the classifying further comprises examining one or more segments of the IR data, wherein the one or more segments is collected over a timeframe.

13. The method of claim 1 further comprising initiating an alarm, by the machine learning model, wherein the initiating is based on the classifying.

14. The method of claim 1 wherein the machine learning model is coupled to a communications device.

15. The method of claim 14 further comprising notifying a user, by the communications device, wherein the notifying is based on the classifying.

16. The method of claim 1 wherein the collecting is based on infrared radiation emitted from the one or more sources of the movement.

17. The method of claim 1 wherein the collecting is based on infrared radiation reflected from the one or more sources of the movement.

18. The method of claim 1 wherein the one or more PIR sensors comprise a differentially opposed PIR sensor.

19. The method of claim 1 wherein the lens comprises a Fresnel lens.

20. A computer system for sensing humans comprising:
an external memory which stores instructions;
one or more processors coupled to the external memory, wherein the one or more processors, when executing the instructions which are stored, are configured to:
access one or more passive infrared (PIR) sensors, wherein the one or more PIR sensors are coupled to a microcontroller, and wherein the one or more PIR sensors are mounted to receive infrared (IR) light through a lens;
collect, from the one or more PIR sensors, IR data, wherein the IR data comprises a time series analog signal;
detect movement, by the one or more PIR sensors, wherein the detecting is based on the collecting;
send, to a machine learning model, the IR data, wherein the machine learning model is based on a TinyML model, and wherein the TinyML model operates on the microcontroller; and
classify, by the TinyML model, one or more sources of the movement.

21. An apparatus for sensing humans comprising:
one or more passive infrared (PIR) sensors located in a housing, wherein the one or more PIR sensors is mounted to receive infrared (IR) light through a lens;
a microcontroller, wherein the microcontroller hosts a convolutional neural network (CNN), and wherein the CNN is based on a TinyML model;
an analog amplifier, wherein the analog amplifier amplifies an output of the one or more PIR sensors; and
a power source, wherein the power source is coupled to provide power to the one or more PIR sensors, the microcontroller, and the analog amplifier, and wherein the power source is contained within, on, or next to the housing.

22. The apparatus of claim 21 wherein the one or more PIR sensors and the microcontroller that hosts the convolutional neural network are used to classify one or more sources a movement.

23. The apparatus of claim 22 wherein the one or more sources of a movement that were classified comprise one or more humans.
